(19) United States
(12) Patent Application Publication
(10) Pub. No.: US 2003/0041043 A1
(43) Pub. Date: Feb. 27, 2003

(54) Sensing and monitoring the environment using intelligent networks

(76) Inventors: Syed Vickar Ahamed, Holmdel, NJ (US); Victor B. Lawrence, Holmdel, NJ (US); Arun N. Netravali, Westfield, NJ (US)

Correspondence Address: Docket Administrator (Room 3J-219), Lucent Technologies Inc., 101 Crawfords Corner Road, Holmdel, NJ, 07733-3030, US

(21) Appl. No.: 09/939,950

(22) Filed: Aug. 27, 2001

(51) Int. Cl. G06N 5/00; G06F 17/00; G06N 7/00; G06N 7/08

(52) U.S. Cl. 706/59

(57) ABSTRACT

Large scale systems can be monitored and, if necessary have an action taken, by employing a knowledge machine that develops programs for at least two machines, the first machine being an information collection system which obtains the latest values of variables, which may be objects, and a second machine which employs the variables in the execution of the program developed for it by the knowledge machine to determine the current state of the large scale system. In response to the monitoring an action may be taken. Advantageously, the environment as it would have existed without the program which controls the second machine having taken previous action may be known, and this information is used to take further action now or in the future. Thus, the system is self learning and self adjusting, allowing it to optimize the environment in an adaptive manner.

### TECHNICAL FIELD

This invention relates to the art of large scale systems which monitor and respond to changes in an environment.

### BACKGROUND OF THE INVENTION

A problem in the art of large scale systems that respond to changes in an environment in order to control at least an element of that environment is that such systems are static, i.e., notwithstanding that they may obtain the latest data, their programs are fixed. In other words, all the responses of such systems are, essentially, preprogrammed as a function of the particular data available at any point in time. This requires that the programmer have a complete insight into the nature of the problem so that he can cause the program to respond properly given each situation presented by the data. Furthermore, there is no way for the programmer to determine, at a first instance in time, the effects that a change made at a previous instance of time had to produce the current environment.

### SUMMARY OF THE INVENTION

We have recognized that large scale systems can be monitored and, if necessary have an action taken, by employing a knowledge machine that develops programs for at least two machines, the first machine being an information collection system which obtains the latest values of variables, which may be objects, and a second machine which employs the variables in the execution of the program developed for it by the knowledge machine to determine the current state of the large scale system. In response to the monitoring an action may be taken. Advantageously, the environment as it would have existed without the program which controls the second machine having taken one or more previous actions may be known, and this information is used to take further action now or in the future, e.g., in response to the current environment or a similar environment that may exist in the future. Thus, the system is self learning and self adjusting, allowing it to optimize the environment in an adaptive manner.

### BRIEF DESCRIPTION OF THE DRAWING

In the drawing:

FIG. 1 shows an exemplary arrangement for monitoring and controlling a large scale system in accordance with the principles of the invention;

FIGS. 2 and 3, when connected together, show an exemplary process for monitoring and controlling a large scale system in accordance with the principles of the invention using the arrangement of FIG. 1; and

FIG. 4 shows a more detailed embodiment of the invention which explicitly shows particular instantiations of functionalities which were more generally referred to in connection with FIG. 1.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

Unless otherwise explicitly specified herein, the drawings are not drawn to scale.

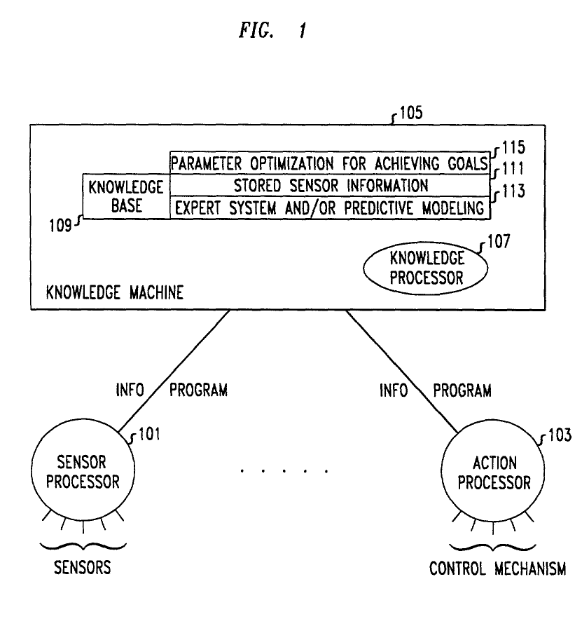

FIG. 1 shows an exemplary arrangement for monitoring and controlling a large scale system in accordance with the principles of the invention. The large scale system to be monitored could be a factory, a corporation, a government, a communication system, an airport or system of airports, railway system, or other similar complex systems. Shown in FIG. 1 are sensor processor 101, action processor 103 and knowledge machine 105. Knowledge machine 105 is coupled to sensor processor 101 and action processor 103. Optionally, sensor processor 101 and action processor 103 may be coupled together as well.

Sensor processor 101 is coupled to various sensors that are positioned so as to collect all the data that is necessary to monitor the operation of the large scale system. Sensor processor 101 reads the information available from the sensors using a program which specifies a prescribed protocol for reading the sensors. In accordance with an aspect of the invention, the program which specifies a prescribed protocol is supplied to sensor processor 101 by knowledge machine 105. The protocol may specify which sensors are read, the periodicity with which they are read, any processing treatment that it may be necessary to apply to the obtained sensor readings, any values that may be required to supply to the sensors, e.g., calibration control values, and the like. Sensor processor 101 may be a network switch which is coupled to various remotely located sensors.

Action processor 103 is coupled to various control mechanisms that are positioned throughout the large scale system in order to control its operation. The control mechanisms may be items such as valves, switches, robotic reactions, changing the interest rate for a financial system, changing the fiscal and/or monetary policy in an economic system, placing or canceling an order in an ordering system, adjusting class size in an educational institution, scheduling appointments or rescheduling conflicting appointments, ordering tests or procedures in medical systems, or the like. In accordance with an aspect of the invention, action processor 103 commands the control mechanisms to operate according to a program which is supplied by knowledge machine 105.

In accordance with the principles of the invention, knowledge machine 105 responds to the operating condition of the large scale system develops the programs to control operation of sensor processor 101 and action processor 103. Knowledge machine 105 includes knowledge processor 107 and knowledge base 109. Knowledge processor 107 executes knowledge processing instructions in knowledge machine 105. Knowledge base 109 contains within itself stored sensor information or its derivative that is received from sensor processor 101. Knowledge base 109 also includes at least one expert system and/or at least one predictive modeling engine 113. Also included within knowledge base 109 are algorithms for optimization of parameters for achieving specified goals. The expert system and/or predictive modeling engine can be used by knowledge machine 105 to analyze the state of the large scale system and to develop a correction program, in accordance with an aspect of the invention, if necessary.

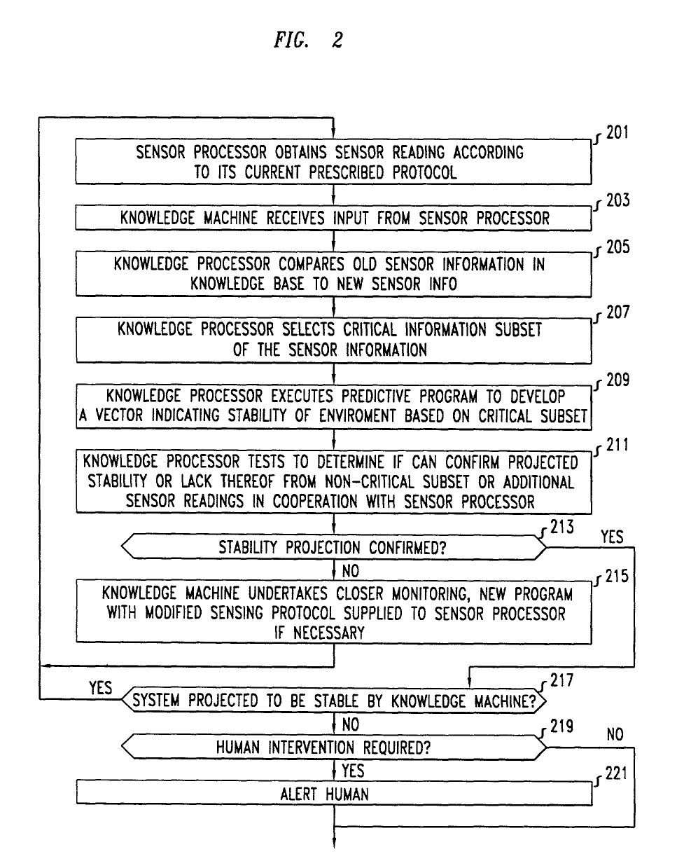

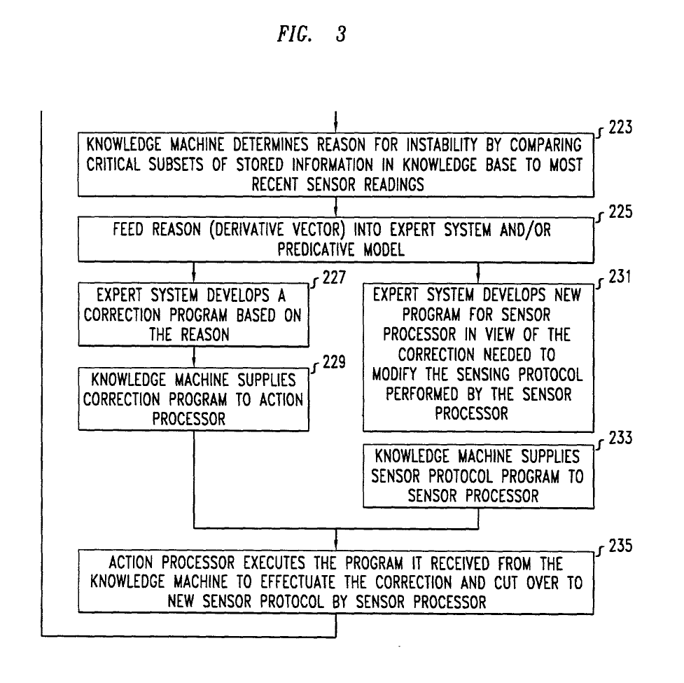

FIGS. 2 and 3, when connected together, show an exemplary process for monitoring and controlling a large scale system in accordance with the principles of the invention using the arrangement of FIG. 1. The process is essentially continually executed once the system of FIG. 1 is activated.

In step 201 sensor processor 101 obtains sensor readings according to the program which specifies its current prescribed protocol as was last supplied to sensor processor 101 by knowledge machine 105. Then, in step 203, knowledge machine 105 receives sensor information which is supplied to it by sensor processor 101. Next, in step 205, knowledge processor 107 compares the old sensor information which is stored in knowledge base 109 with the new sensor information received from sensor processor 101. Knowledge processor 105 selects a critical information of the sensor information in step 207. Thereafter, in step 209, knowledge processor 105 executes a predictive program to develop a vector indicating the stability, or lack thereof, of the operating environment of the large scale system based on the critical subset.

Knowledge processor 105, in step 211, tests to determine if it can confirm the projected stability, or lack thereof, based on the non-critical subset of the current sensor information and/or using additional sensor readings in cooperation with the sensor processor.

Conditional branch point 213 tests to determine if the projection of stability, or lack thereof, is confirmed. If the test result in step 213 is NO, control passes to step 215, in which knowledge machine 105 undertakes to more closely monitor the large scale system. To this end, a new program with a modified sensing protocol is supplied to sensor processor 101, in accordance with an aspect of the invention, if necessary. Control then passes back to step 201, and the process continues as described above.

If the test result in step 217 is YES, indicating that the projection of stability, or lack thereof, is confirmed, control passes to step 217, which tests to determine if knowledge machine 105 is predicting that the system to be stable or not. If the test result in step 217 is YES, indicating that the system is predicted to be stable, control passes back to step 201, and the process continues as described above.

If the test result in step 219 is NO, indicating that the system is predicted to not be stable, control passes to conditional branch point 219, which tests to determine if human intervention is required. Human intervention may be required if the system has become unstable to a preset point, an adaptive point which is determined as a function of various sensor readings, or after repeated application of controls which should correct the detected instability have had little or no success, which might indicate a failure of a control mechanism. If the test result in step 219 is YES, indicating human intervention is required, control passes to step 221, in which knowledge machine 105 causes a human perceivable alert to be activated. After execution of step 221, or if the test result in step 219 was NO, so that no human intervention was necessary, control passes to step 223.

In step 223 knowledge machine 105 determines the reason for the instability by comparing the critical subset of the information stored in knowledge base 109 with the most recent sensor readings supplied by sensor processor 101. As is well known by those of ordinary skill in the art, this reason may be expressed as a difference vector, or a derivative thereof. The reason for the instability, e.g., the vector, is supplied to expert system and/or predictive model 113 in step 225.

The following sets of steps, i.e., steps 227 and 229, as well as steps 231 and 233, may be performed substantially in parallel. However, steps 227, 229, 231, and 233 should all be completed prior to executing step 235.

In accordance with an aspect of the invention, expert system and/or predictive model 113 develops a program based on the reason such that, when executed by action processor 103, the correction program should correct, or at least improve, the stability of the large scale system in step 227. Note that the correction program may be just a patch to the program already executing in action processor 103 or it may be an entire replacement program. Knowledge machine 105, in accordance with an aspect of the invention, supplies the correction program to action processor 103 in step 229.

In step 231, in accordance with an aspect of the invention, expert system and/or predictive model 113 develops a new program for sensor processor 101 to modify the sensing protocol performed by sensor processor 101. Note that the new program may be just a patch for the program already being executed by sensor processor 101. Furthermore, the patch may be a null patch, because even though a new action is required no change in the sensing is required as a result thereof. In the same vein, if the entire program is replaced, the replacing program may be identical with the one it replaces if no change in sensing is required. This new program is developed in view of the corrective actions that must be executed by action processor 103. In step 233 knowledge machine supplied the new sensor protocol program to sensor processor 101.

In step 235 action processor 101 begins to execute the program that it received from knowledge machine 105 to effectuate the required correction in the large scale system. Also in step 235, sensor processor 101 begins to execute the program it received from knowledge machine 105 which specified a new sensor protocol. This synchronization may be implemented through the use of the optional link between sensor processor 101 and action processor 103. Alternatively, knowledge machine 105 may substantially simultaneously transmit a start signal to each of sensor processor 101 and action processor 103.

Control then passes back to step 201 and the process continues as described above.

Note that if human intervention was required because the test result in step 219 was YES, or if a human decides it would be appropriate to intervene for any reason, such intervention could be fed into step 227 so as to impact on the new operation of the large scale system.

Note that by stability, as used herein, it can mean at least stable operation or the meeting of goals which are prespecified and which is supplied as an input to the knowledge machine.

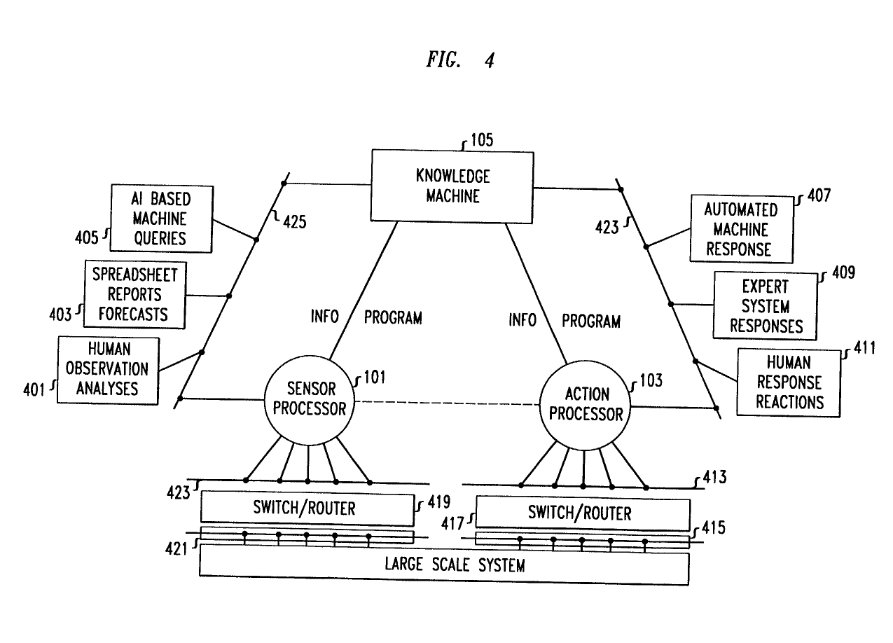

FIG. 4 shows a more detailed embodiment of the invention which explicitly shows particular instantiations of functionalities which were more generally referred to in connection with FIG. 1. More specifically, additional components 401 through 425 perform specific functions which facilitate the realization of the invention with programmable digital processor systems and their typical bus arrangements.

As shown in FIG. 4, sensing functions are realized via sense/input bus 419 which may receive readings taken by sensors 421 via switch/router 419. Knowledge machine 105 may analyze the sensor readings in reference to stored nominal readings 403 as well as stored earlier readings 403, which may be in the form of spreadsheets and may include forecasts. Human observations 401, if any, may also be supplied as an inputs to knowledge machine 105. Machine generated responses and artificial intelligence (AI)-based machine queries 405, may also be employed when the environment in which an embodiment of the invention is employed so warrants. Such queries are initially processed by knowledge machine 105 and may then be sent back to sensor processor 101 for additional data gathering. Such information passes through common processor bus 425.

Output of the knowledge machine 105 may be transported by output bus 423 so as to enable supplementation thereof by automated machine response 407, expert system responses 409 and the human reactions 411. In response, action processor 103 directs, via switch/router 417, the control mechanism 415 in the large scale systems to take appropriate action. Doing so completes a loop from input sensors 421 via switch/router 419 to control mechanism 415 via the output switch/router 417.

What is claimed is:

1. A large scale system, comprising
a first processor, said first processor being an information collection system for obtaining current values of parameters representing an environment of said large scale system;
a second processor for determining actions to be taken in said environment in response to said current values collected by said first processor;
a knowledge machine for developing a first program for said first processor and a second program for said second processor, said first and second programs being such as to cause said first and second machine to monitor and control said environment.

2. The invention as defined in claim 1 wherein said first program causes said first machine to collect information as a function of the application for which said large scale system is being employed.

3. The invention as defined in claim 1 wherein said first program causes said first machine to collect information as a function of the actions being taken by said second processor.

4. The invention as defined in claim 1 wherein said first program causes said first machine to determine what are the parameters for which values need to be collected.

5. The invention as defined in claim 1 wherein said first program causes said first machine to determine what are the parameters for which values need to be collected, said first program using an initial list of parameters supplied by said knowledge machine and further developing a list of at least one additional parameters.

6. The invention as defined in claim 1 wherein said first machine is a network switch.

7. The invention as defined in claim 1 wherein said knowledge machine further comprises a knowledge base and a knowledge processor.

8. The invention as defined in claim 7 wherein said knowledge base consists of at least one element from the set consisting of: a parameter optimization unit, stored sensor information, an expert system, and a predictive modeling engine.

9. The invention as defined in claim 1 wherein said first and second processors are coupled together to coordinate their initiation of execution of said first and second programs.

10. A method for use in operating a large scale system using a monitoring and control arrangement in which a first processor senses the operating condition of said large scale system, a second processor determines actions to be taken in said system, said first and second processors being coupled to a knowledge machine, the method comprising the steps of:
developing in said knowledge machine a first program for said first processor and a second program for said second processor, said first and second programs being such as to cause said first and second machine to monitor and control said environment when executed by said first and second machines, respectively;
transmitting, by said knowledge machine, of said first program to said first machine;
transmitting, by said knowledge machine, of said second program to said second machine; and
coordinating initial execution of said first program by said first machine and initial execution of said second program by said second machine to be substantially simultaneous.

11. The invention as defined in claim 10 wherein said knowledge machine develops said first and second programs when a projection of system instability by said knowledge machine is confirmed.

12. The invention as defined in claim 11 further comprising the steps of:
predicting, by said knowledge processor, based on a critical subset of sensor information that said large scale system is not stable; and
confirming said prediction that said large scale system is not stable using additional information beyond said critical subset.

13. The invention as defined in claim 11 further comprising the step of:
determining at least one reason for said system instability.

14. The invention as defined in claim 11 wherein said first and second programs are developed to address and correct said at least one reason for said system instability.

15. The invention as defined in claim 10 wherein said first program includes an indication of a sensing protocol.

16. The invention as defined in claim 10 wherein said second program includes an indication of controls in said large scale system to undergo a state change.

17. The invention as defined in claim 10 further comprising the steps of:
determining that human intervention is required; and
initiating a human perceivable alert.

18. Apparatus for use in operating a large scale system using a monitoring and control arrangement in which a first processor senses the operating condition of said large scale system, a second processor determines actions to be taken in said system, said first and second processors being coupled to a knowledge machine, the apparatus comprising:
means for developing in said knowledge machine a first program for said first processor and a second program for said second processor, said first and second programs being such as to cause said first and second machine to monitor and control said environment when executed by said first and second machines, respectively;
means for transmitting, by said knowledge machine, of said first program to said first machine;
means for transmitting, by said knowledge machine, of said second program to said second machine; and
means for coordinating initial execution of said first program by said first machine and initial execution of said second program by said second machine to be substantially simultaneous.
